(19) United States
(12) Patent Application Publication
(10) Pub. No.: US 2025/0369260 A1
(43) Pub. Date: Dec. 4, 2025

(54) LIMITING APPARATUS

(71) Applicant: SINOX CO., LTD., New Taipei City (TW)

(72) Inventors: Chia-Ming WU, New Taipei City (TW); Jia-Ci WU, New Taipei City (TW); Yu-Jui CHANG, New Taipei City (TW)

(73) Assignee: SINOX CO., LTD., New Taipei City (TW)

(21) Appl. No.: 18/946,600

(22) Filed: Nov. 13, 2024

Related U.S. Application Data
(60) Provisional application No. 63/654,303, filed on May 31, 2024.

(51) Int. Cl. E05B 73/00; E05B 37/02

(52) U.S. Cl. CPC E05B 73/0082; E05B 37/02; E05B 73/0005

(57) ABSTRACT

A limiting apparatus is configured to be used with an electronic device, and includes a support member and an engagement member. The support member is provided with a support surface. The support surface includes a convex portion. The engagement member movably engages with the support member. When the limiting apparatus is in a locked state, a relative position of the support member and the engagement member is fixed, to limit the electronic device in the limiting apparatus.

### TECHNICAL FIELD

The present utility model relates to a limiting apparatus. Further, the present utility model relates to a limiting apparatus for an electronic device.

### BACKGROUND

A consumer electronic product plays an important role in modern life. In addition, because of a rapid life style and needs of people for real-time information currently, portable electronic products become one of necessities of people. However, due to high unit prices and ease of monetization, possibility of theft of these products also increases.

To prevent stealing, a limiting apparatus is provided, for example, a notebook computer lock. A locking member of the notebook computer lock can be connected to an anti-theft locking hole of an electronic product. In addition, a key lock mechanism controls movement of the locking member, to implement unlocking/locking. However, specifications of the anti-theft locking hole are different, so that a user needs to purchase/carry the limiting apparatus with the corresponding locking member based on the specifications of the anti-theft locking hole. This is uneconomic, and also inconvenient to use.

### SUMMARY

An objective of the present utility model is to provide a limiting apparatus, which can implement a fixing effect without using a locking hole, and has better convenience of use.

The limiting apparatus is configured to be used with an electronic device, and includes a support member and an engagement member. The support member is provided with a support surface. The support surface includes a convex portion. The engagement member movably engages with the support member. When the limiting apparatus is in a locked state, a relative position of the support member and the engagement member is fixed, to limit the electronic device in the limiting apparatus.

The limiting apparatus further includes a housing, a support member, a driving apparatus, and a lock body. An end of the housing is provided with a front end opening. The support member is fixed outside the front end opening. The engagement member is arranged in the housing, can rotate relative to the housing, and includes a front end portion and a rear end portion. The front end portion at least partially protrudes out of the front end opening, and the rear end portion extends along a direction opposite to the front end portion. The driving apparatus includes a force application member and a driving member. The force application member includes a force receiving portion and a force application portion. The force application portion is arranged in the housing. The force receiving portion is connected to the force application portion. The force application member can rotate in conjunction relative to the housing. The driving member is arranged in the housing, and rotates in conjunction with the force application portion to selectively move on a side of the rear end portion, so that a distance between the front end portion relative to the support member changes. The lock body is arranged on a side of the driving apparatus. When the lock body is locked, the lock body restricts movement of the driving apparatus.

In an embodiment of the present utility model, the support surface extends along an X-axis. The X-axis, a Y-axis, and a Z-axis are orthogonal.

In an embodiment of the present utility model, the engagement member can rotate relative to the housing along a plane parallel to a Y-Z plane, the force application member can rotate along a plane parallel to an X-Z plane, and the driving member can move selectively along a Y-axis direction.

In an embodiment of the present utility model, the support surface includes a convex portion.

In an embodiment of the present utility model, the force application portion includes a limiting portion, and an end of the driving member can engage with the limiting portion in a manner of along a Y-axis direction.

In an embodiment of the present utility model, the driving apparatus further includes a displacement limiting member fixed in the housing. The displacement limiting member is internally provided with an accommodation space extending along the Y-axis direction. A sidewall thread is arranged on a sidewall of the accommodation space. The driving member is arranged in the accommodation space. The driving member is a cylinder whose side surface is arranged with a driving member thread that matches the sidewall thread. When the force application member rotates, the driving member rotates in conjunction, and the driving member moves along the Y-axis direction through an action between the sidewall thread and the driving member thread.

In an embodiment of the present utility model, the housing is internally provided with an accommodation space extending along the Y-axis direction. A sidewall thread is arranged on a sidewall of the accommodation space. The driving member is arranged in the accommodation space. The driving member is a cylinder whose side surface is arranged with a driving member thread that matches the sidewall thread. When the force application member rotates, the driving member rotates in conjunction, and the driving member moves along the Y-axis direction through an action between the sidewall thread and the driving member thread.

In an embodiment of the present utility model, the lock body includes the engagement member movable along a Z-axis direction. When the lock body is locked, an end of the engagement member engages with the force application member, to limit rotation of the force application member.

In an embodiment of the present utility model, the lock body is a key lock, and the engagement member includes a convex post.

In an embodiment of the present utility model, the lock body is a combination lock, and includes a shaft movable along a Y-axis direction. The shaft has a shaft end portion. The engagement member includes a bump movable along the Z-axis direction. A side of the bump abuts against the shaft end portion. When the lock body is locked, another side of the bump can engage with the force application member, to limit the rotation of the force application member.

In an embodiment of the present utility model, the limiting apparatus further includes a driving apparatus, and the driving apparatus includes a force application member, a driving member, and a displacement limiting member. The force application member is a cylinder with a partially closed end, and includes a force receiving portion and a force application portion. The force application portion is a concave portion arranged on an inner side of the partially closed end. An end of the driving member is a polygonal block whose outer contour matches a contour of the force application portion. The displacement limiting member is arranged in the force application member, and can rotate coaxially with the force application member along the Y-axis direction. A relative position of the displacement limiting member along the Y-axis direction remains unchanged.

In an embodiment of the present utility model, the limiting apparatus further includes a housing, a lock body, a driving apparatus, and an assembly. The lock body is arranged in the housing, the driving apparatus is arranged in the lock body, and the assembly is separably arranged in the housing and adjacent to the lock body. The support member and the engagement member are assembled in the assembly, so that the engagement member can rotate relative to the assembly, and the front end portion and the rear end portion can be close to or away from the support member respectively.

In an embodiment of the present utility model, one side of the support member is provided with the support surface, and another side of the support member is provided with a support member hole. The top of the engagement member is provided with a flange, and a side of the engagement member is provided with an engagement member hole. The engagement member can move transversely relative to the support member and engage with the support member, and the support member hole and the engagement member hole at least partially run through each other.

In an embodiment of the present utility model, one side of the support member is provided with the support surface, and another side is provided with a support member hole. The top of the engagement member is provided with a flange. A side of the engagement member is provided with an engagement member hole. The engagement member can move up and down relative to the support member and engage with the support member, and the support member hole and the engagement member hole at least partially run through each other.

In an embodiment of the present utility model, one side of the support member is provided with the support surface, and another side of the support member is provided with a support member hole. The top of the engagement member is provided with a flange. A side of the engagement member is provided with an engagement member hole. The engagement member can move forward and backward relative to the support member and engage with the support member, and the support member hole and the engagement member hole at least partially run through each other.

### BRIEF DESCRIPTION OF THE DRAWINGS

FIG. 1A and FIG. 1B are schematic diagrams of an embodiment of a limiting apparatus according to the present utility model;

FIG. 1C and FIG. 1D are exploded schematic diagrams of an embodiment of a limiting apparatus according to the present utility model;

FIG. 1E to FIG. 1I are schematic diagrams of an operation of an embodiment of the limiting apparatus according to the present utility model;

FIG. 2A to FIG. 2E are schematic diagrams different embodiments of a limiting apparatus according to the present utility model;

FIG. 3A to FIG. 3H are schematic diagrams of different embodiments of a limiting apparatus according to the present utility model;

FIG. 4A to FIG. 4G are schematic diagrams of different embodiments of a limiting apparatus according to the present utility model;

FIG. 5A to FIG. 5I are schematic diagrams of different embodiments of a limiting apparatus according to the present utility model;

FIG. 6A to FIG. 6F are schematic diagrams of different embodiments of a limiting apparatus according to the present utility model; and

FIG. 7A to FIG. 7F are schematic diagrams of different embodiments of a limiting apparatus according to the present utility model.

### DETAILED DESCRIPTION

A limiting apparatus is configured to be used with an electronic device. The electronic device is preferably portable, for example, but not limited to, a notebook computer, a tablet computer, a mobile phone, an e-book, a digital photo frame, a global positioning system navigation machine, a mobile network device, a personal digital assistant, a digital walkman, or an electronic dictionary.

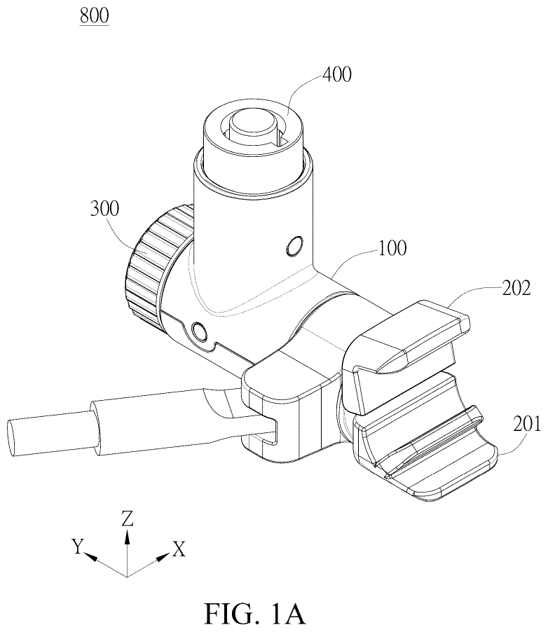

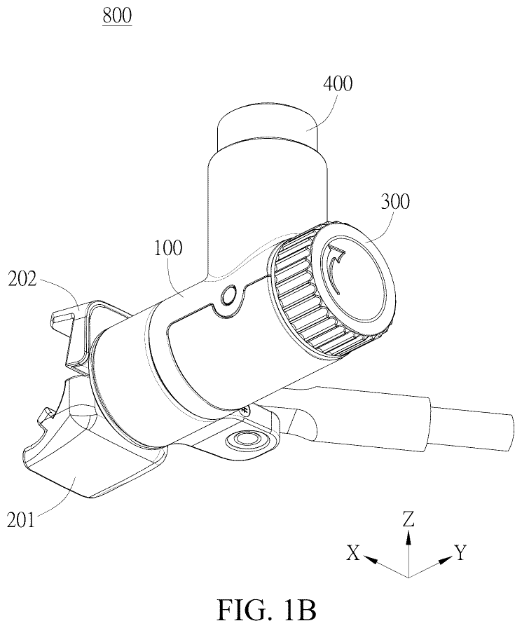

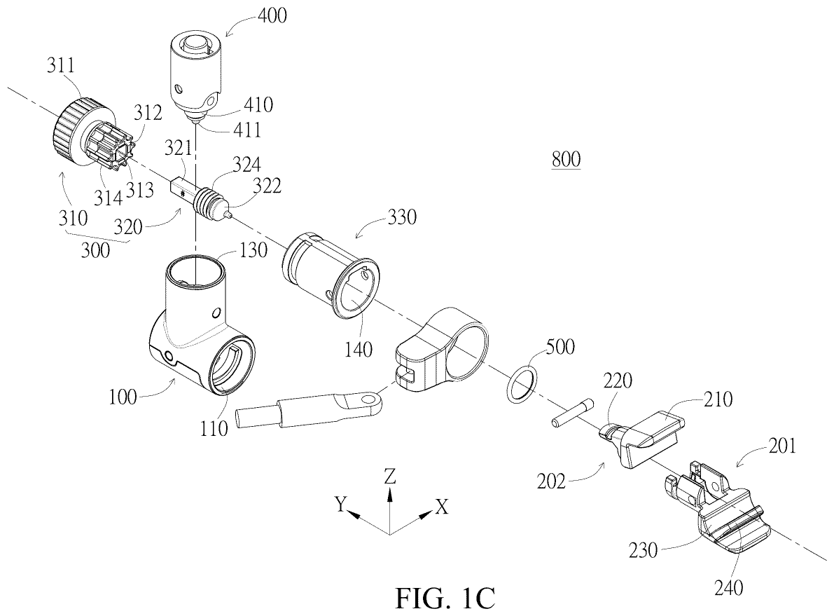

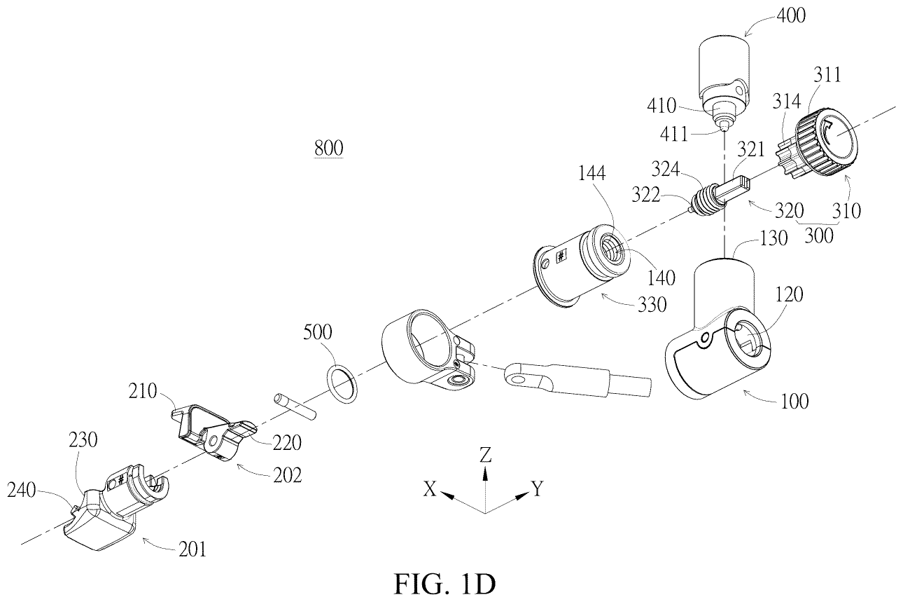

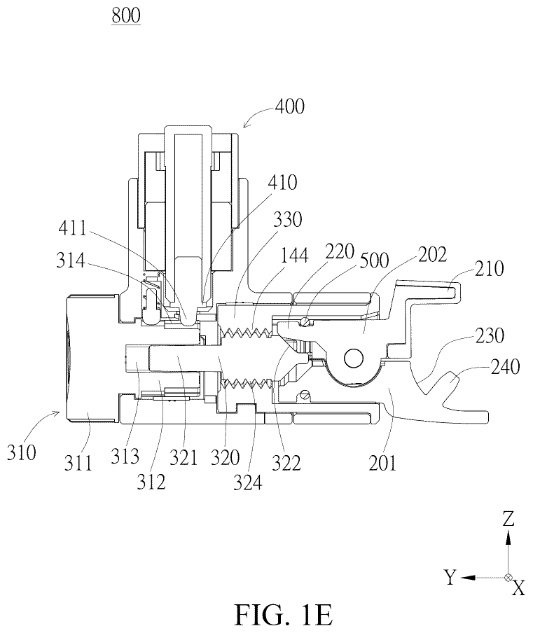

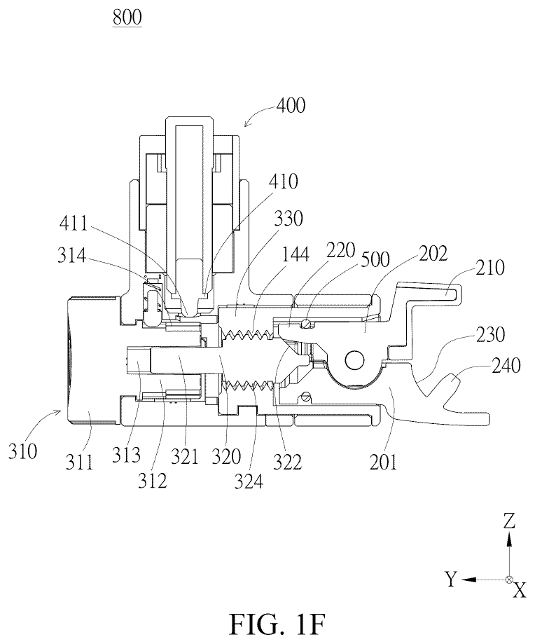

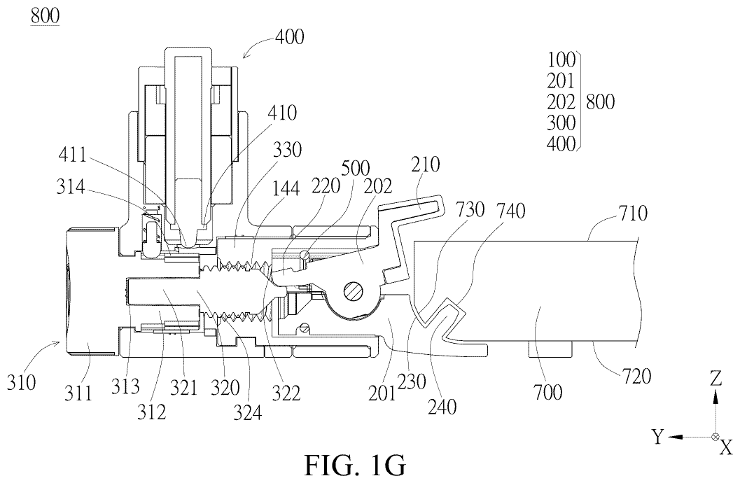

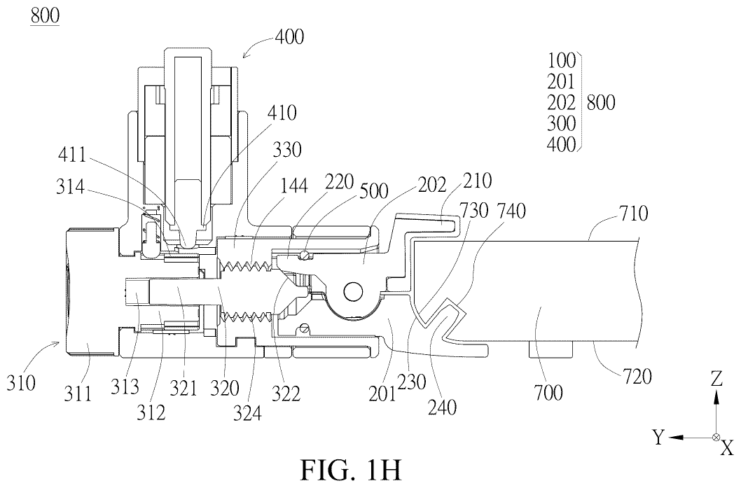

In embodiments shown in FIG. 1A to FIG. 1D, a limiting apparatus 800 in the present utility model includes a support member 201 and an engagement member 202. The support member 201 is provided with a support surface 230, and the support surface 230 includes a convex portion 240. The engagement member 202 movably engages with the support member 201. When the limiting apparatus 800 is in a locked state, a relative position of the support member 201 and the engagement member 202 is fixed, to limit the electronic device in the limiting apparatus 800. More specifically, in this embodiment, the limiting apparatus 800 further includes a housing 100, a driving apparatus 300, and a lock body 400. In the embodiments shown in FIG. 1C and FIG. 1D, an end of the housing 100 is provided with a front end opening 110. The support member 201 is fixed outside the front end opening 110. The support surface 230 extends along an X-axis, that is, can be considered as extending along a transverse direction. The engagement member 202 is arranged in the housing 100, can rotate relative to the housing 100, and includes a front end portion 210 and a rear end portion 220. The front end portion 210 at least partially protrudes out of the front end opening 110, and the rear end portion 220 extends along a direction opposite to the front end portion 210. In this embodiment, the engagement member 202 can rotate relative to the housing 100 along a plane parallel to a Y-Z plane. In other words, when the engagement member 202 rotates, the front end portion 210 and the rear end portion 220 can be considered as opening and closing up and down relative to the support member 201. The X-axis, a Y-axis, and a Z-axis are orthogonal.

In the embodiments shown in FIG. 1C and FIG. 1D, the driving apparatus 300 includes a force application member 310 and a driving member 320. The force application member 310 includes a force receiving portion 311 and a force application portion 312. The force application portion 312 is arranged in the housing 100. The force receiving portion 311 is connected to the force application portion 312. The force application member 310 can rotate in conjunction relative to the housing 100. Further, in the embodiment shown in FIG. 1D, the housing 100 includes a rear end opening 120, the force receiving portion 311 and the force application portion 312 pass through the housing 100 through the rear end opening 120 to connect to each other, and at least a part of the force receiving portion 311 is exposed to the housing 100. However, in different embodiments, the force receiving portion 311 is entirely arranged in the housing 100, or at least does not protrude from the housing 100. A user can apply force to the force receiving portion 311 by using a tool such as a screwdriver, to rotate the force receiving portion 311.

In the embodiments shown in FIG. 1C and FIG. 1D, the lock body 400 is arranged on a side of the driving apparatus 300. When the lock body 400 is locked, the lock body 400 restricts movement of the driving apparatus 300. More specifically, the force application portion 312 is a cylinder with a plurality of convex members 314 arranged on a periphery. The lock body 400 includes an engagement member 410 in a manner of moving along a Z-axis direction. When the lock body 400 is locked, an end of the engagement member 410 extends into the plurality of convex members 314, to limit rotation of the force application member 310. The engagement member 410 includes a convex post 411. However, in different embodiments, the force application portion 312 is not limited to the cylinder with the plurality of convex members 314 arranged on the periphery, and the engagement member 410 only needs to be limited through shape complementation, friction, or the like. For example, the force application portion 312 can be provided with a plurality of holes on the periphery for insertion of the convex post 411. In other words, when the lock body 400 is locked, the end of the engagement member 410 engages with the force application member 310, to limit the rotation of the force application member 310. In this embodiment, the lock body 400 is a key lock configured to be used with a key (not shown), for example, but not limited to, a key that is connected to an outside of the housing 100 through the side opening 130 for insertion and operation.

In the embodiments shown in FIG. 1C and FIG. 1D, the driving member 320 is arranged in the housing 100, and rotates in conjunction with the force application portion 312 to selectively move on a side of the rear end portion 220, so that a distance between the front end portion 210 relative to the support member 201 changes. In this embodiment, the force application portion 312 includes a limiting portion 313, and an end 321 of the driving member 320 engages with the limiting portion 313 in a manner of moving along a Y-axis direction, so that the driving member 320 rotates in conjunction with the force application member 310. More specifically, the limiting portion 313 is a polygonal hole, and the end 321 of the driving member 320 is a polygonal cylinder whose outer contour matches the end 321. Therefore, when the end 321 of the driving member 320 is inserted into the limiting portion 313, an engaging effect is generated along a direction parallel to an X-Z plane, so that the driving member 320 can rotate in conjunction with the force application member 310 along the plane parallel to the X-Z plane. However, the end 321 and the limiting portion 313 have no engaging effect along the Y-axis direction, so that the end 321 and the limiting portion 313 can move along the Y-axis direction. However, in different embodiments, an object that matches the driving member 320 and the limiting portion 313 can be of other designs, and can be plural.

Further, in the embodiments shown in FIG. 1D and FIG. 1E, the driving apparatus 300 further includes a displacement limiting member 330 fixed in the housing 100. The displacement limiting member 330 is internally provided with an accommodation space 140 extending along the Y-axis, and a sidewall thread 144 is arranged on a sidewall of the accommodation space 140. The driving member 320 is arranged in the accommodation space 140, and the driving member 320 is a cylinder whose side surface is arranged with a driving member thread 324 that matches the sidewall thread 144. Through an abutting action between the sidewall thread 144 and the driving member thread 324, when the force application member 310 rotates along the plane parallel to the X-Z plane, the driving member 320 rotates in conjunction, so that the driving member 320 moves along the Y-axis direction to extend into different depths to a position on the side of the rear end portion 220, and the distance between the front end portion 210 and the support member 201 changes. An end 322 of the driving member 320 facing the rear end portion 220 has an inclined surface, which helps the end 322 to move along the Y-axis direction to extend into different depths to the position on the side of the rear end portion 220 and abut against the rear end portion 220. However, in different embodiments, the accommodation space 140 can be directly arranged in the housing 100, that is, the sidewall thread 144 is directly arranged on an inner side of the housing 100, and use of the displacement limiting member 330 is omitted. In addition, the limiting apparatus 800 further includes an clastic member 500, for example, a rubber ring, configured to provide clastic force to enable the rear end portions 220 to approach each other.

The following further describes an operation of the limiting apparatus 800 of the present utility model.

In the embodiment shown in FIG. 1E, when the lock body 400 is locked, the end of the engagement member 410 extends into the plurality of convex members 314, to limit rotation of the force application member 310. Because the driving member 320 rotates in conjunction with the force application member 310, the rotation of the driving member 320 relative to the housing 100 is also limited. Therefore, the driving member 320 cannot move along the Y-axis direction to change a position relative to a side of the rear end portion 220. In other words, in this case, the driving member 320 fixedly abuts against the rear end portion 220, so that the distance between the front end portion 210 and the support member 201 is fixed.

In the embodiment shown in FIG. 1F, when the lock body 400 is unlocked, for example, by using the key, the end of the engagement member 410 exits between the plurality of convex members 314, to release restriction on the rotation of the force application member 310, and also release restriction on the rotation of the driving member 320 relative to the housing 100. In this case, in the embodiment shown in FIG. 1G, the user can rotate the force application member 310 along a first rotation direction by applying force to the force receiving portion 311, to drive the driving member 320 to rotate, and move the driving member 320 along the Y-axis direction by abutting between the sidewall thread 144 and the driving member thread 324, to move away from the front end portion 210, so that the distance between the front end portion 210 and the support member 201 is increased. Therefore, a part of an electronic device 700 can be placed between the front end portion 210 and the support member 201. Further, in this embodiment, a side edge of a host of the notebook computer used as the electronic device 700 is placed between the front end portion 210 and the support member 201, so that an upper surface 710 on a side of a keyboard faces the front end portion 210, and a part of a lower surface 720 and an end surface 730 are supported by the support member 201.

Then, in the embodiment shown in FIG. 1H, the user can rotate the force application member 310 along a direction opposite to the first rotation direction by applying force to the force receiving portion 311, to drive the driving member 320 to rotate, so that the driving member 320 moves along the Y-axis direction to approach the front end portion 210, so that the distance between the front end portion 210 and the support member 201 is reduced to a point that a part of the electronic device 700 can be limited between the front end portion 210 and the support member 201. Then, in the embodiment shown in FIG. 1I, the user can use, for example, the key, to enable the lock body 400 to be locked, that is, the end of the engagement member 410 extends into the plurality of convex members 314, to limit the rotation of the force application member 310, so that the distance between the front end portion 210 and the support member 201 is fixed, to fix the electronic device 700. A contour of the support surface 230 matches a part of the lower surface 720 and a contour of the end surface 730, to obtain a better support and a fixing effect. In the embodiment in which the lower surface 720 or the end surface 730 includes a groove portion 740, the support surface 230 includes the convex portion 240 that can engage with the groove portion 740, to improve the fixing effect.

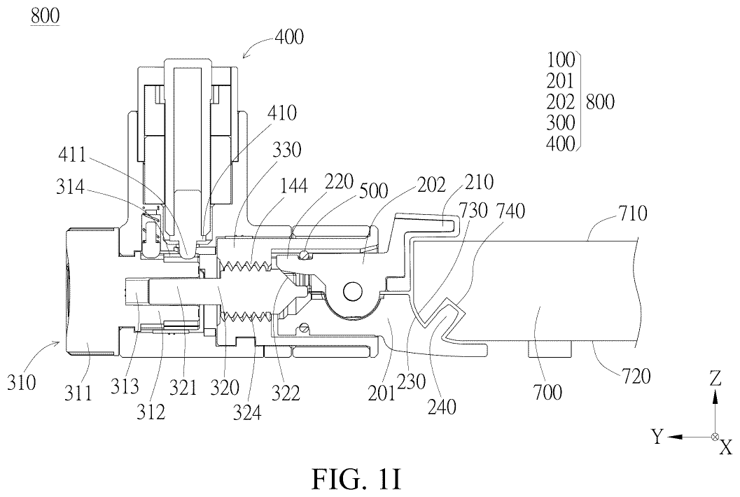

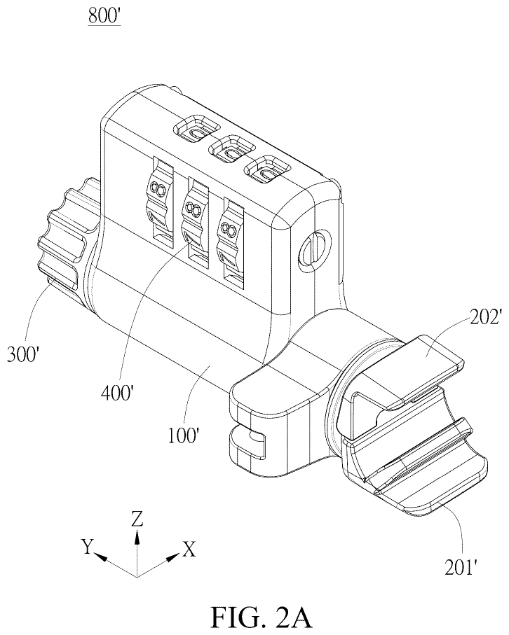

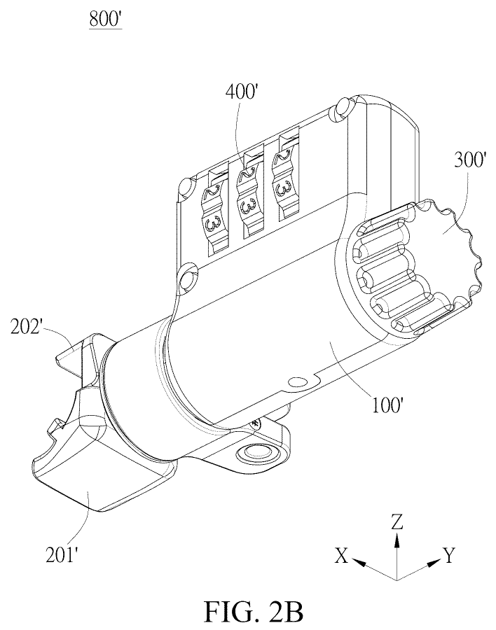

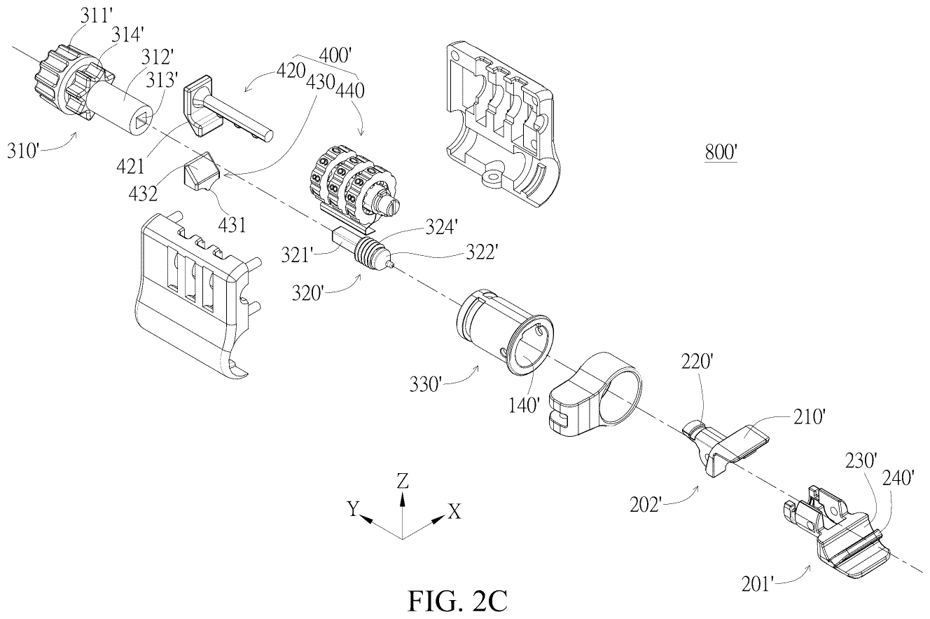

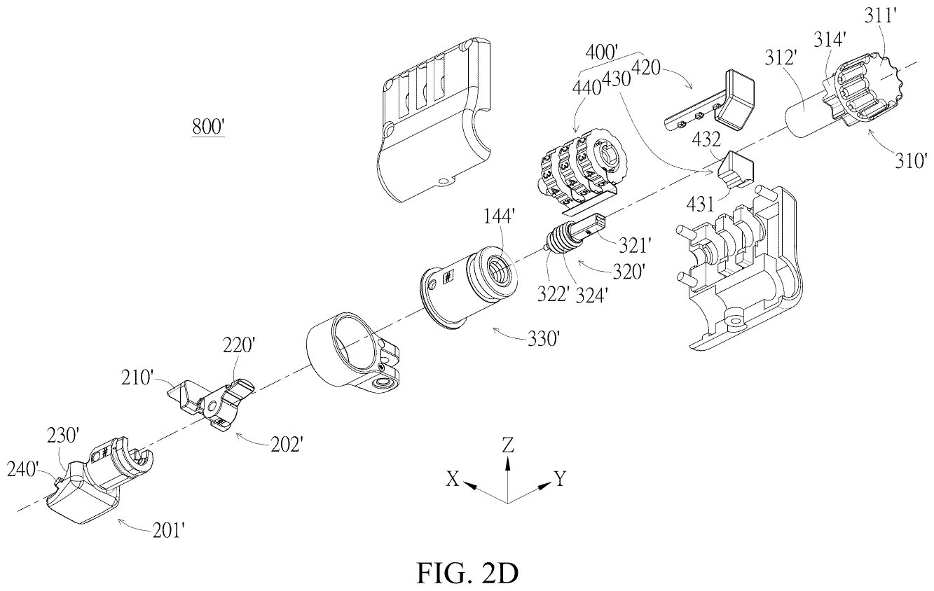

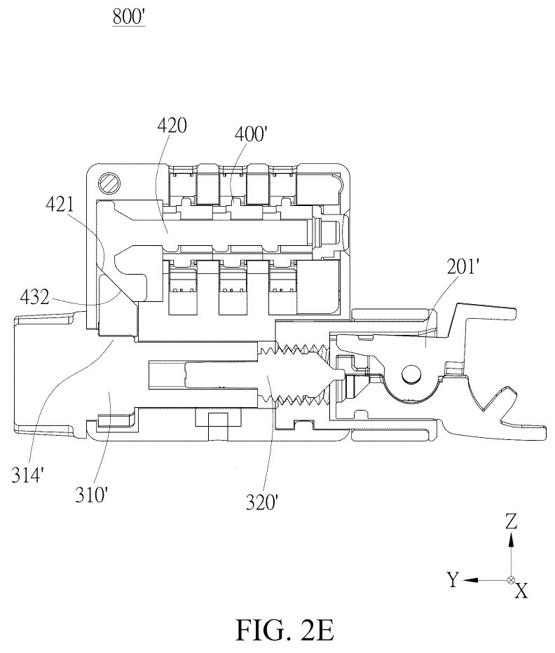

In different embodiments, a lock body 400′ can be a lock body other than a key lock. In embodiments shown in FIG. 2A to FIG. 2E, the lock body 400′ is a combination lock. Further, in the embodiments shown in FIG. 2C to FIG. 2E, the lock body 400′ is the combination lock, and includes a shaft 420 movable along a Y-axis direction. The shaft 420 has a shaft end portion 421. The engagement member includes a limiting member 430 movable along a Z-axis direction. The limiting member 430 includes a bump. In the embodiment shown in FIG. 2E, a side 432 of the limiting member 430 abuts against the shaft end portion 421. When the lock body 400′ is locked, another side 431 can engage with a force application member 310′, to limit rotation of the force application member 310′. In other words, in this embodiment, the shaft 420 of the lock body 400′ extends along the Y-axis direction, and moves along the Z-axis direction through the limiting member 430 to engage with the force application member 310′. However, in different embodiments in which, for example, the shaft 420 of the lock body 400′ extends along the Z-axis direction, an end of the shaft can directly engage with the force application member, so that the limiting member 430 does not need to be arranged.

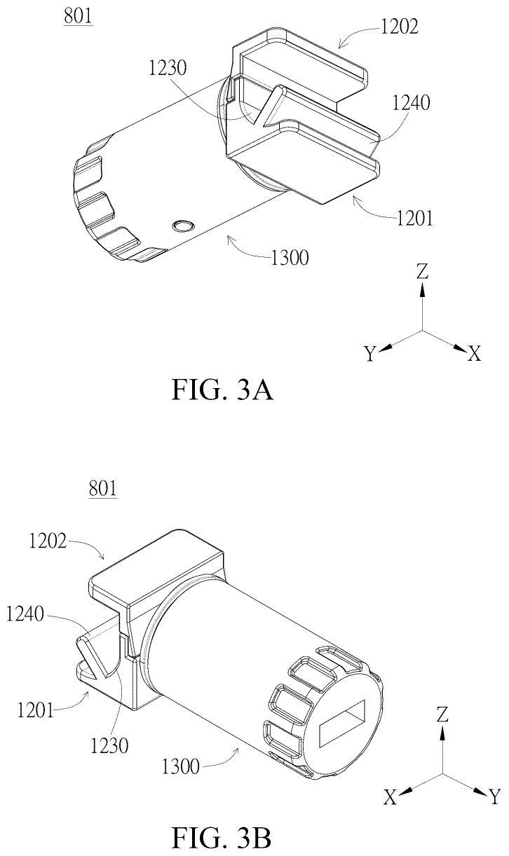

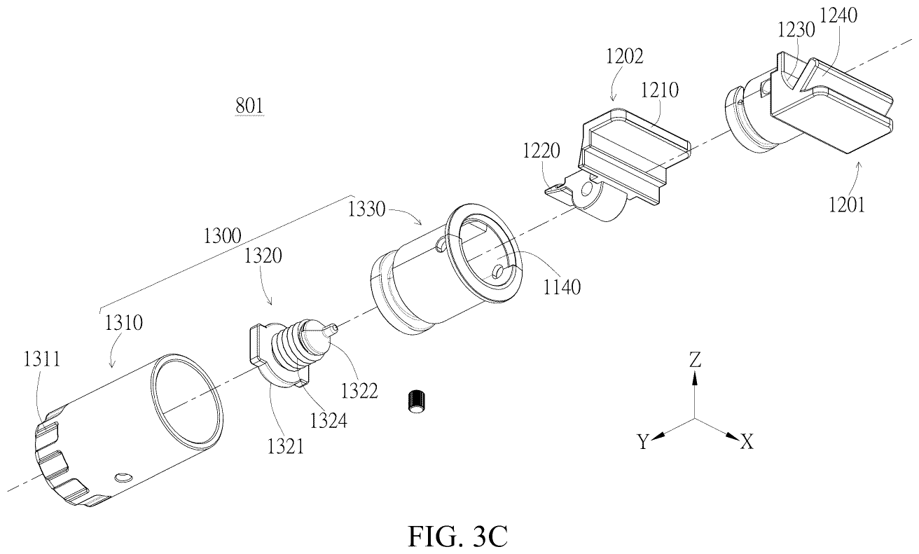

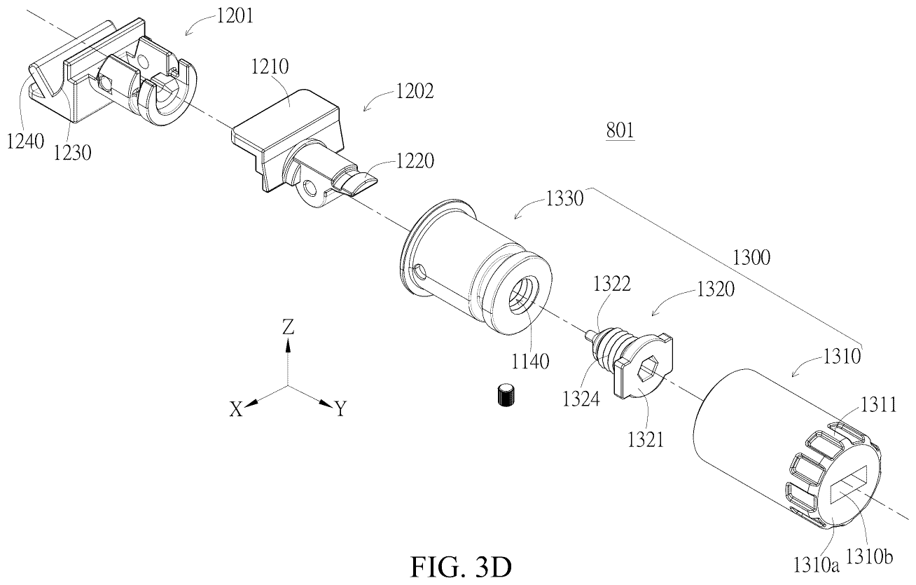

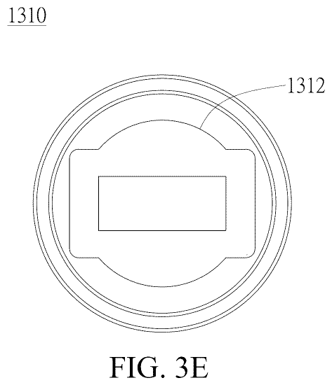

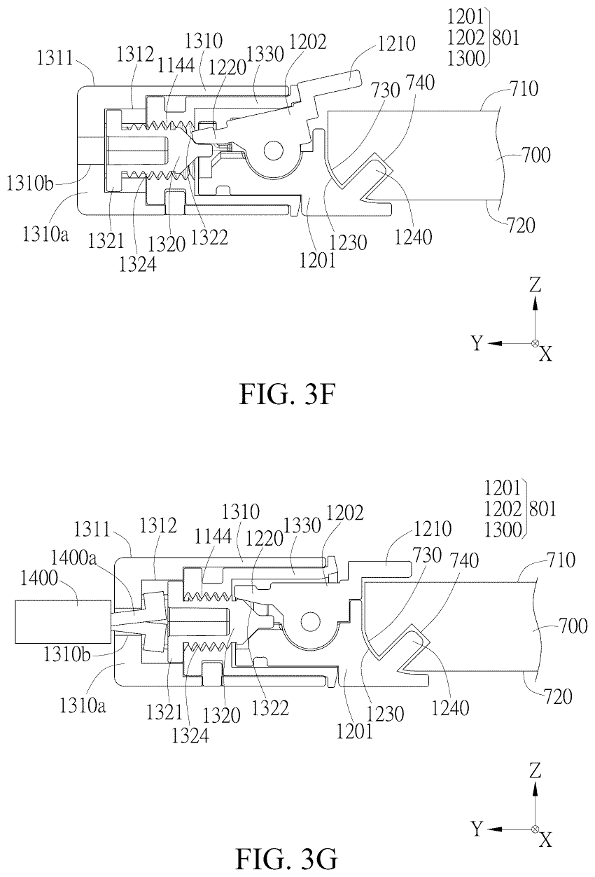

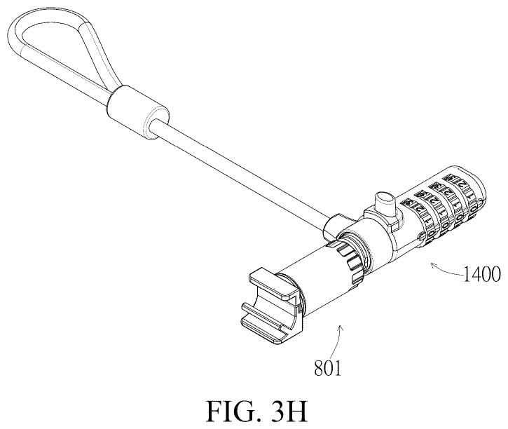

In different embodiments, the driving apparatus 300 can vary based on requirements. In embodiments shown in FIG. 3A to FIG. 3D, a limiting apparatus 801 includes a support member 1201, an engagement member 1202, and further includes a driving apparatus 1300. In the embodiments shown in FIG. 3C and FIG. 3D, the driving apparatus 1300 includes a force application member 1310, a driving member 1320, and a displacement limiting member 1330. More specifically, the force application member 1310 is a cylinder with an at least partially closed end, and includes a force receiving portion 1311 and a force application portion 1312 (referring to FIG. 3E). The force application portion 1312 is a concave portion arranged on an inner side of a partially closed end 1310a. An end 1321 of the driving member 1320 is a polygonal block whose outer contour matches the end 1321 of the driving member 1320. Therefore, when the end 1321 of the driving member 1320 is inserted into the force application portion 1312, an engaging effect is generated along an X-Z plane direction, so that the driving member 1320 can rotate in conjunction with the force application member 1310. In addition, because the end 1321 and the force application portion 1312 have no engaging effect along the Y-axis direction, the end 1321 and the force application portion 1312 can move relatively along the Y-axis direction.

In addition, in embodiments shown in FIG. 3F and FIG. 3G, the displacement limiting member 1330 is arranged in the force application member 1310, and the displacement limiting member 1330 can rotate coaxially along the Y-axis direction. However, a relative position of the displacement limiting member 1330 along the Y-axis direction remains unchanged. The displacement limiting member 1330 is internally provided with an accommodation space 1140 extending along the Y-axis (referring to FIG. 3C), and a sidewall thread 1144 is arranged on a sidewall of the accommodation space 1140. The driving member 1320 is arranged in the accommodation space 1140, and the driving member 1320 is a cylinder whose side surface is arranged with a driving member thread 1324 that matches the sidewall thread 1144. Through an abutting action between the sidewall thread 1144 and the driving member thread 1324, when the force application member 1310 rotates along the plane parallel to the X-Z plane, the driving member 1320 rotates in conjunction, so that the driving member 1320 moves along the Y-axis direction to extend into different depths to a position on a side of a rear end portion 1220, and a distance between a front end portion 1210 and the support member 1201 changes. An end 1322 of the driving member 1320 facing the rear end portion 1220 has an inclined surface, which helps the end 1322 to move along the Y-axis direction to extend into different depths to the position on the side of the rear end portion 1220 and abut against the rear end portion 1220.

More specifically, in the embodiment shown in FIG. 3F, a user can rotate the force application member 1310 along a first rotation direction by applying force to the force receiving portion 1311, to drive the driving member 1320 to rotate, and move the driving member 1320 along the Y-axis direction by abutting between the sidewall thread 1144 and the driving member thread 1324, to move away from the front end portion 1210, so that the distance between the front end portion 1210 and the support member 1201 is increased. Therefore, a part of the electronic device 700 can be placed between the front end portion 1210 and the support member 1201. Further, in this embodiment, a side edge of a host of a notebook computer used as the electronic device 700 is placed between the front end portion 1210 and the support member 1201, so that an upper surface 710 on a side of the keyboard faces the front end portion 1210, and a part of a lower surface 720 and an end surface 730 are supported by the support member 1201.

Then, in the embodiment shown in FIG. 3G, the user can rotate the force application member 1310 along a direction opposite to a second rotation direction by applying force to the force receiving portion 1311, to drive the driving member 1320 to rotate, so that the driving member 1320 moves along the Y-axis direction to approach the front end portion 1210, so that the distance between the front end portion 1210 and the support member 1201 is reduced to a point that a part of the electronic device 700 can be limited between the front end portion 1210 and the support member 1201. Then, the user can, for example, pass a hook member 1400a of a lock body 1400 through a hole 1310b of the partially closed end 1310a, place the hook member 1400a at a position other than the end 1321 in the force application portion 1312, and then lock the lock body 1400, that is, the limiting apparatus 801 is in a locked state. In this case, because movement of the driving member 1320 along the Y-axis direction is limited by the hook member 1400a, and the distance between the front end portion 1210 and the support member 1201 is fixed, to fix the electronic device 700. When the limiting apparatus 801 is in the locked state, a relative position of the lock body 1400 and the limiting apparatus 801 is shown in FIG. 3H.

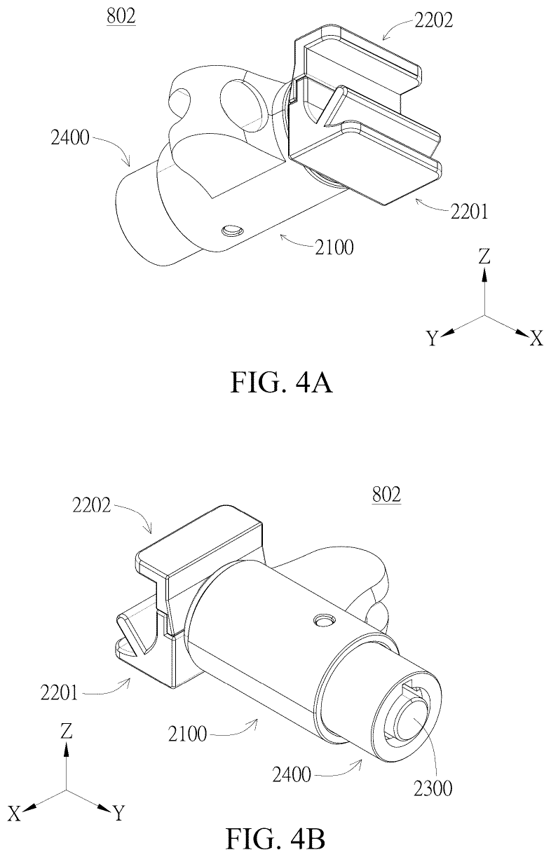

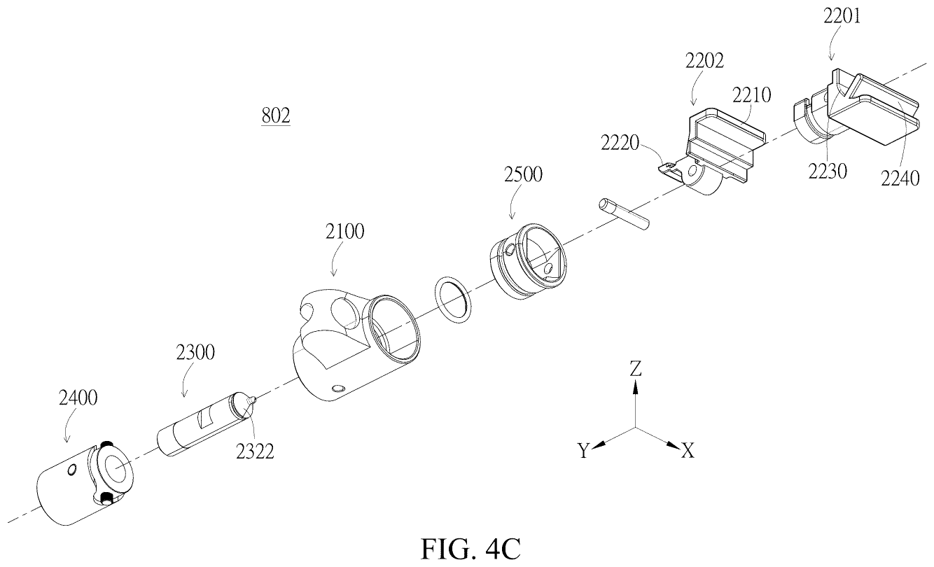

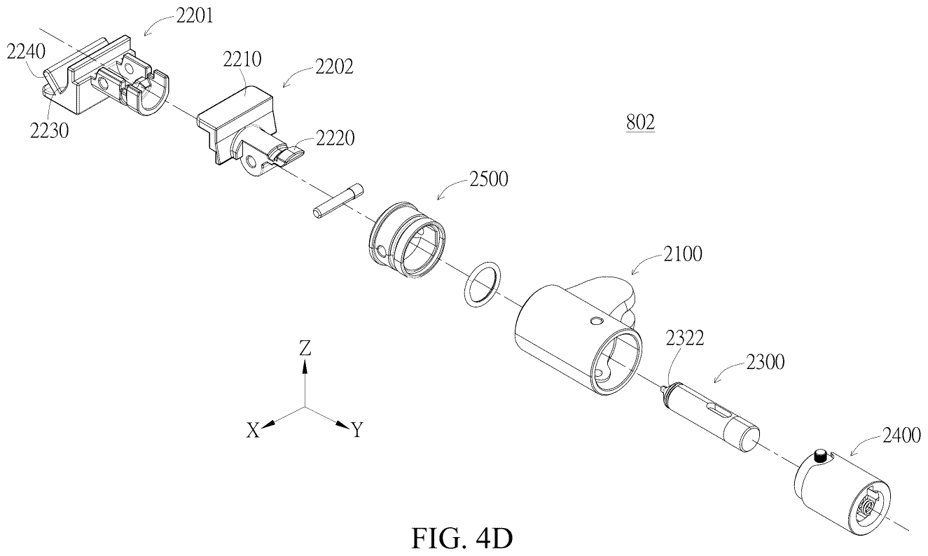

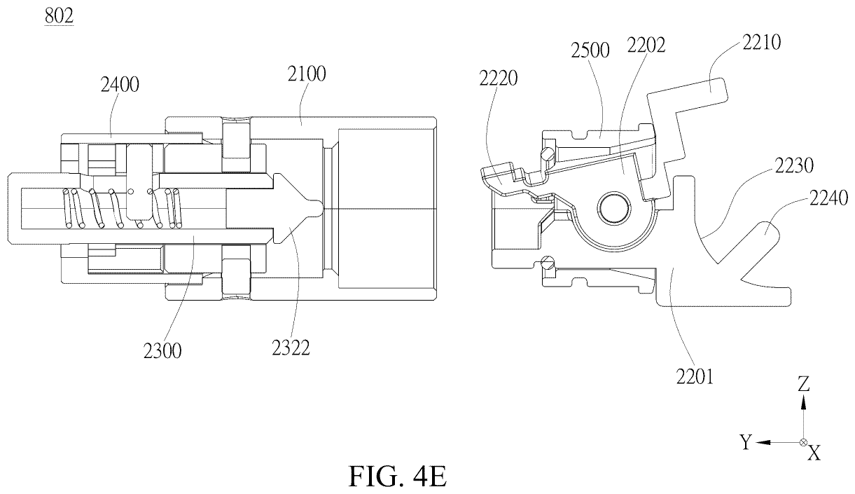

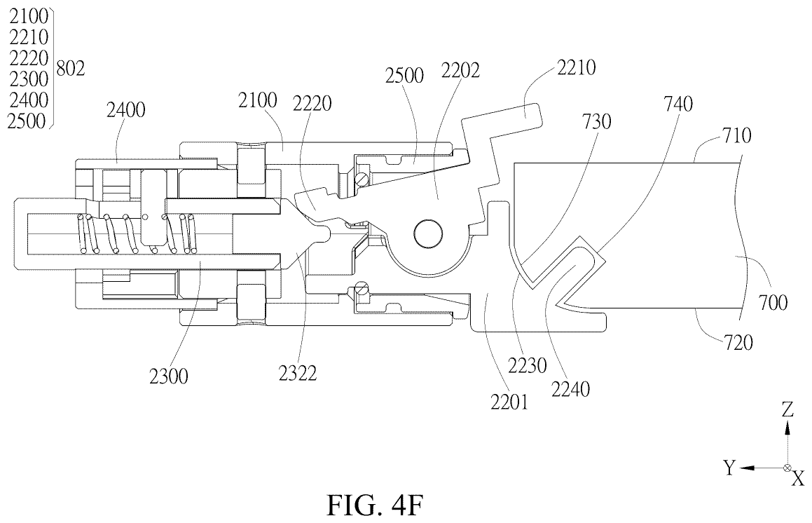

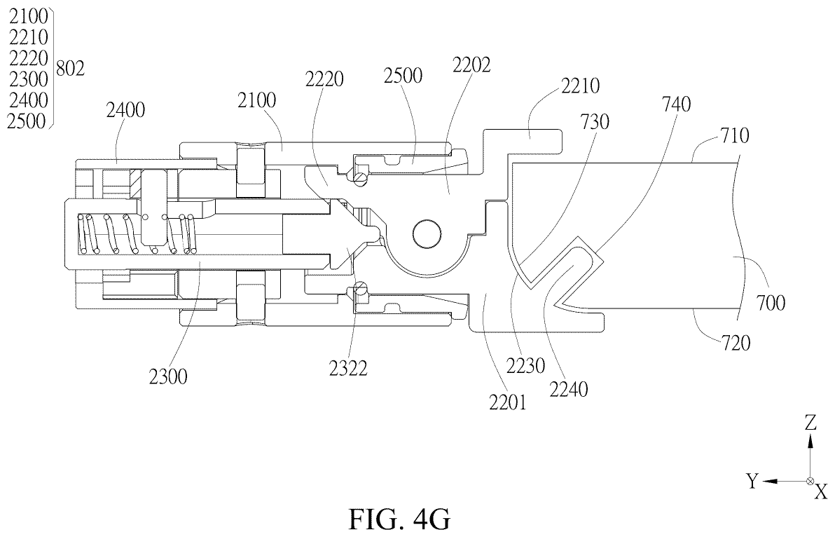

In embodiments shown in FIG. 4A to FIG. 4D, a limiting apparatus 802 includes a support member 2201 and an engagement member 2202, and further includes a housing 2100, a driving apparatus 2300, a lock body 2400, and an assembly 2500. In embodiments shown in FIG. 4E and FIG. 4F, the driving apparatus 2300 is arranged in the lock body 2400, the lock body 2400 is arranged in the housing 2100, and the assembly 2500 is separably arranged in the housing 2100 and adjacent to the lock body 2400. The support member 2201 and the engagement member 2202 are assembled in the assembly 2500, so that the engagement member 2202 can rotate relative to the assembly 2500, and a front end portion 2210 and a rear end portion 2220 can be close to or away from the support member 2201 respectively. From a different angle, the driving apparatus 2300 can be a shaft of the lock body 2400.

Specifically, in the embodiment shown in FIG. 4F, when the lock body 2400 is unlocked, that is, when the limiting apparatus 802 is in an unlocked state, the driving apparatus 2300 moves along a Y-axis direction to move away from the front end portion 2210, so that a distance between the front end portion 2210 and the support member 2201 is increased. Therefore, a part of the electronic device 700 can be placed between the front end portion 2210 and the support member 2201. Further, in this embodiment, a side edge of a host of a notebook computer used as the electronic device 700 is placed between the front end portion 2210 and the support member 2201, so that an upper surface 710 on a side of the keyboard faces the front end portion 2210, and a part of a lower surface 720 and an end surface 730 are supported by the support member 2201.

Then, in the embodiment shown in FIG. 4G, the user can move the driving apparatus 2300 along the Y-axis direction by applying force to the driving apparatus 2300 along the Y-axis direction, to approach the front end portion 2210, so that the distance between the front end portion 2210 and the support member 2201 is reduced to a point that a part of the electronic device 700 can be limited between the front end portion 2210 and the support member 2201. An end 2322 of the driving apparatus 2300 facing the rear end portion 2220 has an inclined surface, which helps the end 2322 to move along the Y-axis direction to extend into different depths to the position on the side of the rear end portion 2220 and abut against the rear end portion 2220. When the lock body 2400 is locked, that is, when the limiting apparatus 802 is in a locked state, movement of the driving apparatus 2300 along the Y-axis direction is limited. In this case, because the end 2322 abuts against the rear end portion 2220, and the distance between the front end portion 2210 and the support member 2201 is fixed, to fix the electronic device 700. In addition, in this case, because the rear end portion 2220 is away from the support member 2201, that is, is open relative to the support member 2201, the assembly 2500 can engage with the housing 2100. In other words, when the lock body 2400 is locked, the assembly 2500 engages with the housing 2100. When the lock body 2400 is unlocked, the assembly 2500 can be separated from the housing 2100. Because the assembly 2500 is separably arranged in the housing 2100, the assembly 2500 and the included support member 2201 and engagement member 2202 can be substantially replaced as needed, to be more effectively adapt to a to-be-fixed electronic device. For example, the support member 2201 replaced with the support surface 2230 with a large curvature, to better support the electronic device 700 with the end surface 730 with the large curvature.

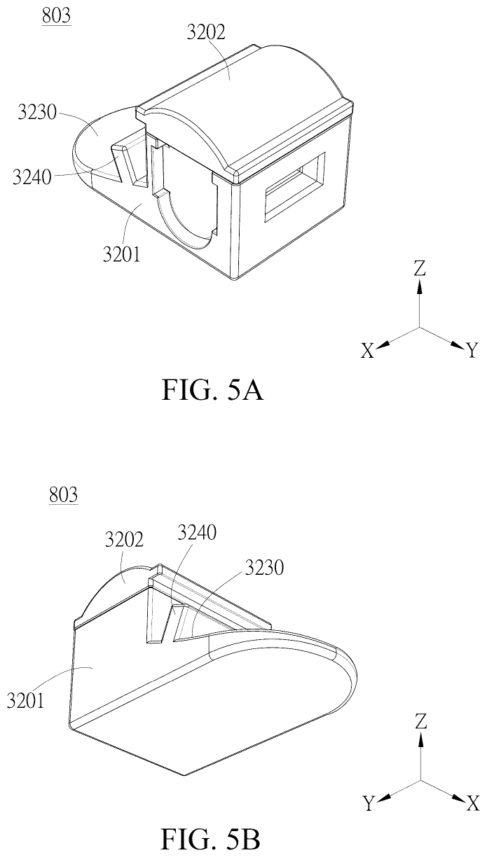

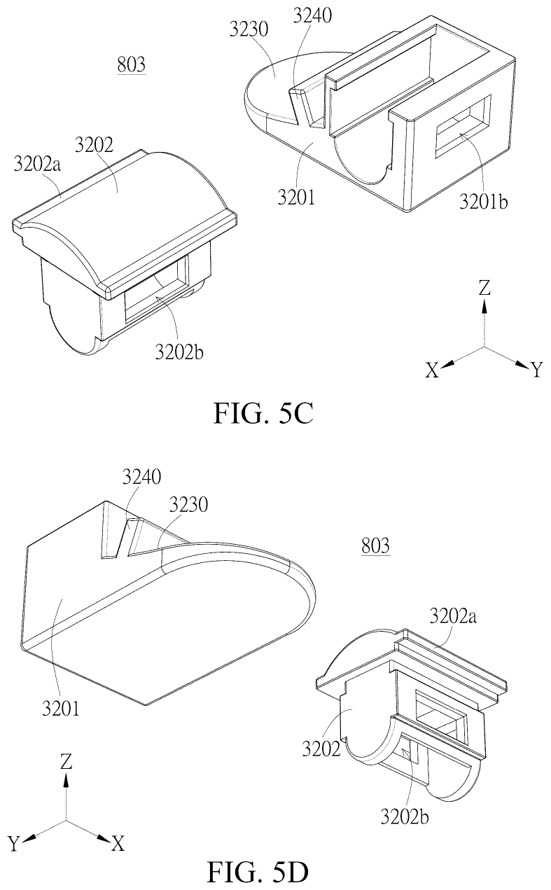

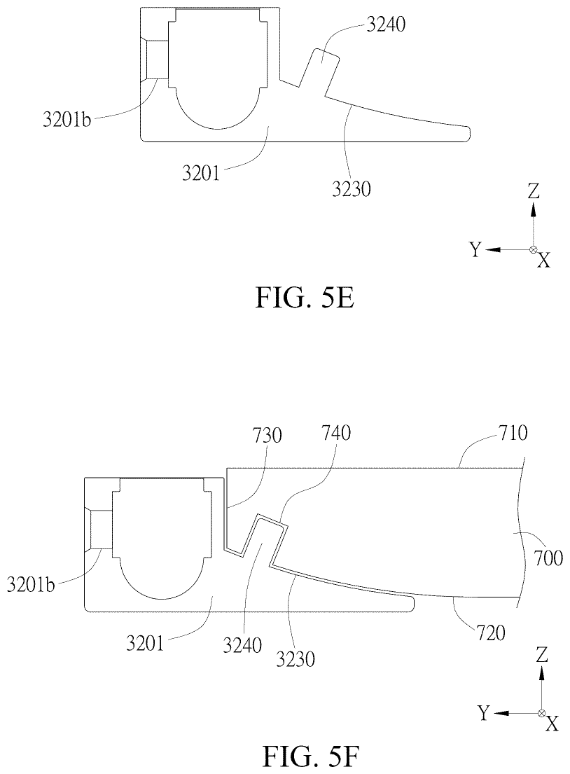

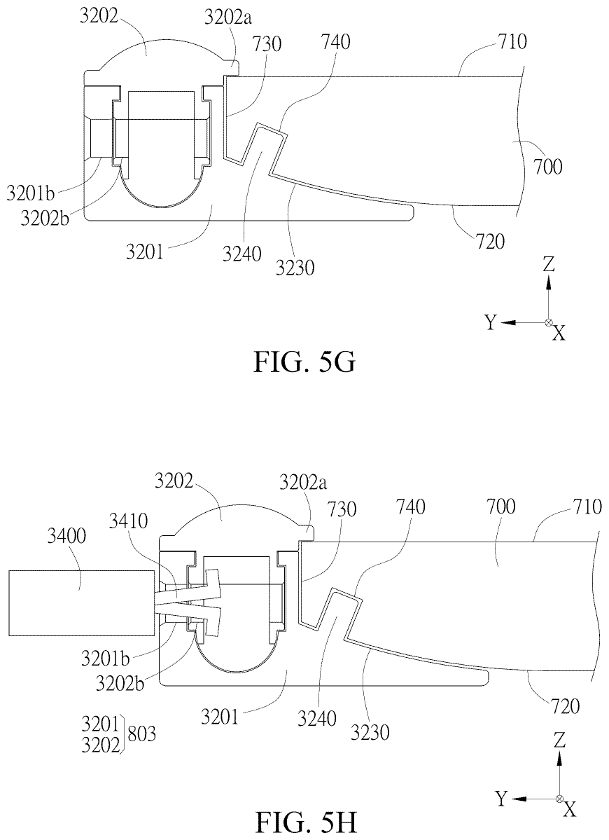

In embodiments shown in FIG. 5A to FIG. 5D, a limiting apparatus 803 includes a support member 3201 and an engagement member 3202. Further, in the embodiments shown in FIG. 5C and FIG. 5D, one side of the support member 3201 is provided with a support surface 3230, the support surface 3230 includes a convex portion 3240, and another side of the support member 3201 is provided with a support member hole 3201b. The top of the engagement member 3202 is provided with a flange 3202a, and a side of the engagement member 3202 is provided with an engagement member hole 3202b. The engagement member 3202 can move along an X-axis direction to engage with the support member 3201, and bumps of the support member hole 3201b and the engagement member hole 3202b are at least partially overlapped on an X-Z plane. In other words, the engagement member 3202 can move transversely relative to the support member 3201 and engage with the support member 3201, and the support member hole 3201b and the engagement member hole 3202b at least partially run through each other.

In embodiments shown in FIG. 5E and FIG. 5F, the user can place a part of the electronic device 700 on the support member 3201. Further, in this embodiment, a side edge of a host of a notebook computer used as the electronic device 700 is placed on the support member 3201, so that a part of the lower surface 720 on a side of a keyboard is supported by the support member 3201. Then, in the embodiment shown in FIG. 5G, the user can move the engagement member 3202 along the X-axis direction to engage with the support member 3201, and bumps of the support member hole 3201b and the engagement member hole 3202b are at least partially overlapped on the X-Z plane. Therefore, a distance between the flange 3202a and the support member 3201 can be reduced to an extent that a part of the electronic device 700 can be limited between the flange 3202a and the support member 3201. Then, the user can, for example, pass a hook member 3410 of a lock body 3400 through the support member hole 3201b and the engagement member hole 3202b, and then lock the lock body 3400, that is, the limiting apparatus 803 is in a locked state. In this case, because movement of the engagement member 3202 relative to the support member 3201 is limited by the hook member 3410, and a distance of the flange 3202a relative to the support member 3201 is fixed, to fix the electronic device 700. When the limiting apparatus 803 is in the locked state, a relative position of the lock body 3400 and the limiting apparatus 803 is shown in FIG. 51.

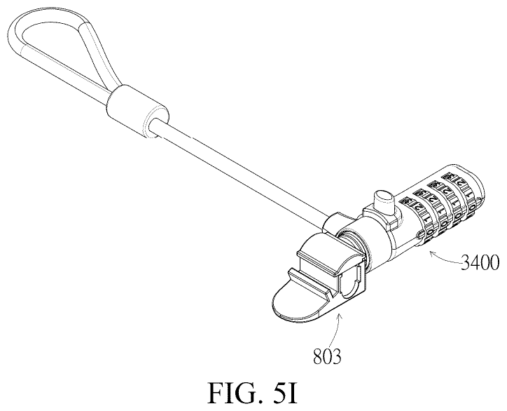

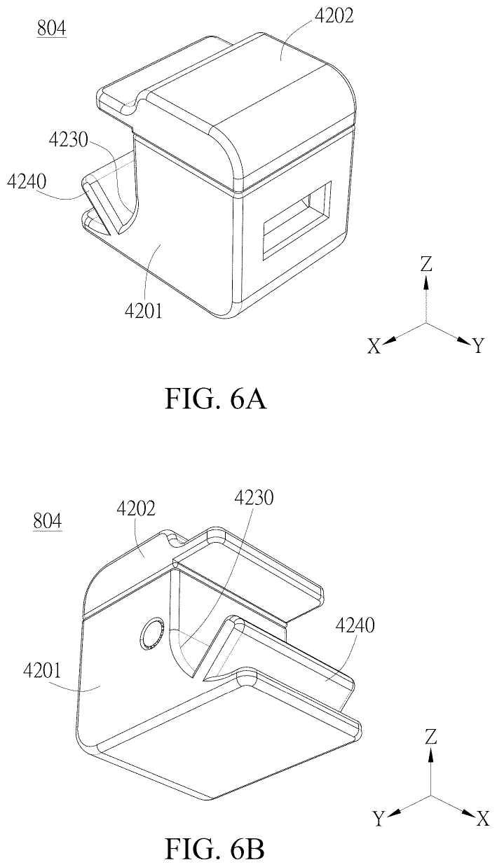

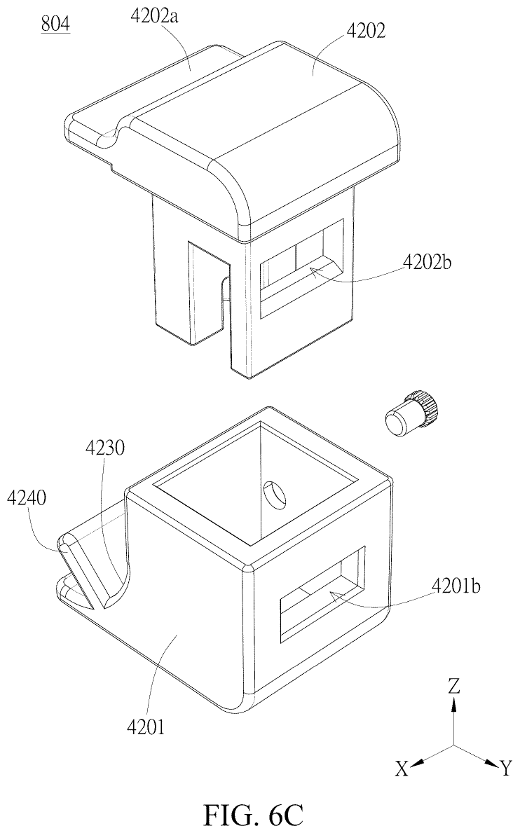

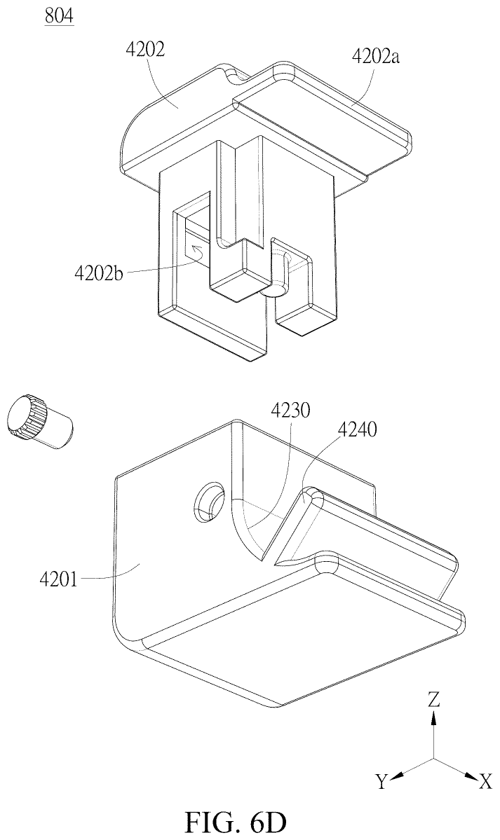

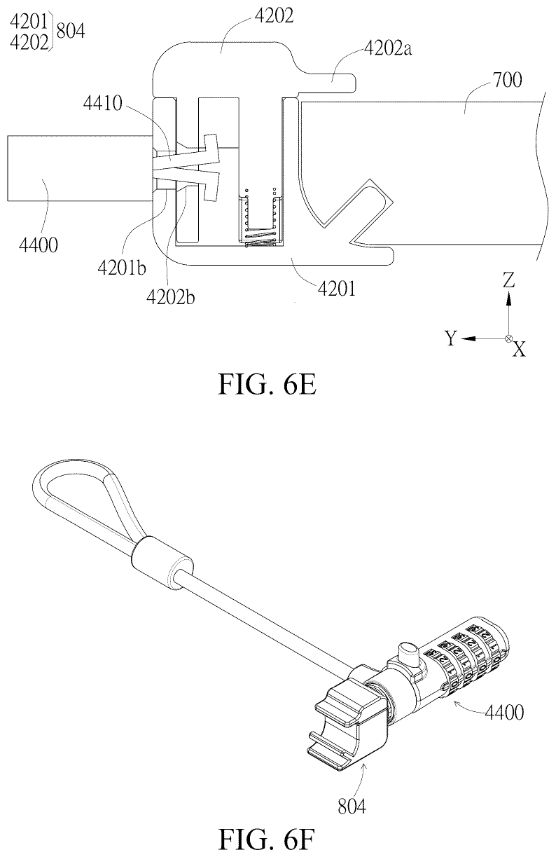

In different embodiments, the engagement member is not limited to movable along the X-axis direction to engage with the support member. In embodiments shown in FIG. 6A to FIG. 6D, a limiting apparatus 804 includes a support member 4201 and an engagement member 4202. Further, in the embodiments shown in FIG. 6C and FIG. 6D, one side of the support member 4201 is provided with a support surface 4230, the support surface 4230 includes a convex portion 4240, and another side of the support member 4201 is provided with a support member hole 4201b. The top of the engagement member 4202 is provided with a flange 4202a, and a side of the engagement member 4202 is provided with an engagement member hole 4202b. The engagement member 4202 can move along a Z-axis direction to engage with the support member 4201, and bumps of the support member hole 4201b and the engagement member hole 4202b are at least partially overlapped on an X-Z plane. In other words, the engagement member 4202 can move vertically relative to the support member 4201 and engage with the support member 4201, and the support member hole 4201b and the engagement member hole 4202b at least partially run through each other.

In the embodiment shown in FIG. 6E, a user can place a side edge of a host of a notebook computer used as the electronic device 700 on the support member 4201, and move the engagement member 4202 along the Z-axis direction to engage with the support member 4201, and bumps of the support member hole 4201b and the engagement member hole 4202b are at least partially overlapped on the X-Z plane. Therefore, a distance between the flange 4202a and the support member 4201 can be reduced to an extent that a part of the electronic device 700 can be limited between the flange 4202a and the support member 4201. Then, the user can, for example, pass a hook member 4410 of a lock body 4400 through the support member hole 4201b and the engagement member hole 4202b, and then lock the lock body 4400, that is, the limiting apparatus 804 is in a locked state. In this case, because movement of the engagement member 4202 relative to the support member 4201 is limited by the hook member 4410, and a distance of the flange 4202a relative to the support member 4201 is fixed, to fix the electronic device 700. When the limiting apparatus 804 is in the locked state, a relative position of the lock body 4400 and the limiting apparatus 804 is shown in FIG. 6F.

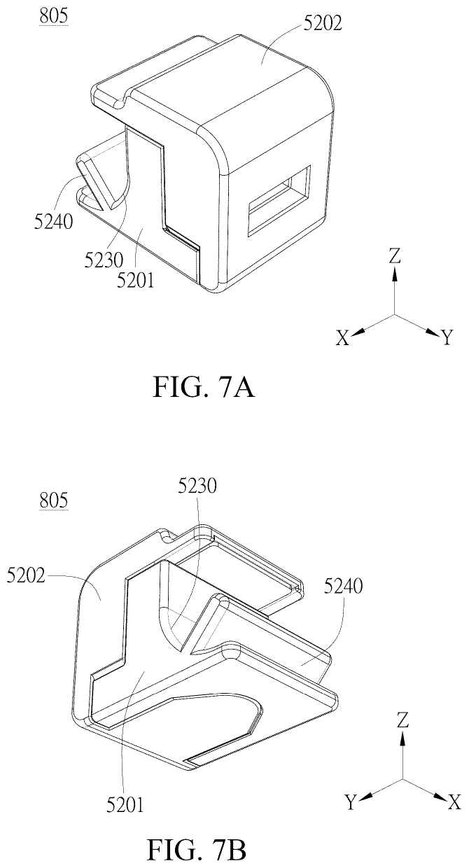

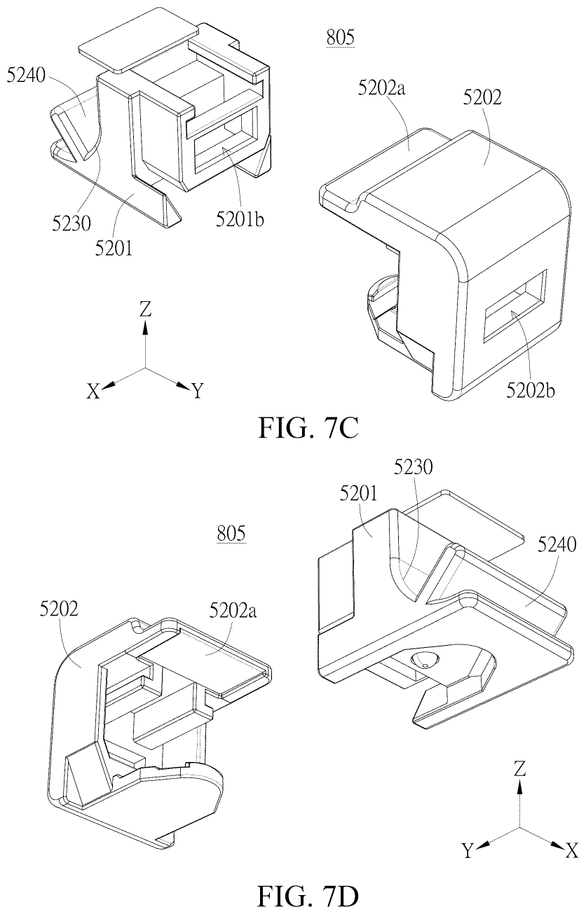

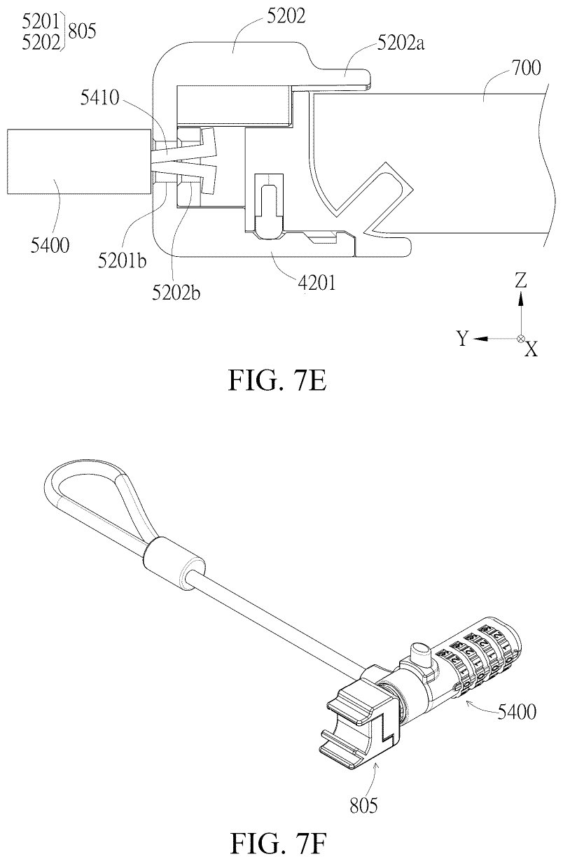

In embodiments shown in FIG. 7A to FIG. 7D, a limiting apparatus 805 includes a support member 5201 and an engagement member 5202. Further, in the embodiments shown in FIG. 7C and FIG. 7D, one side of the support member 5201 is provided with a support surface 5230, the support surface 5230 includes a convex portion 5240, and another side of the support member 5201 is provided with a support member hole 5201b. The top of the engagement member 5202 is provided with a flange 5202a, and a side of the engagement member 5202 is provided with an engagement member hole 5202b. The engagement member 5202 can move along a Y-axis direction to engage with the support member 5201, and bumps of the support member hole 5201b and the engagement member hole 5202b are at least partially overlapped on an X-Z plane. In other words, the engagement member 5202 can move forward and backward relative to the support member 5201 and engage with the support member 5201, and the support member hole 5201b and the engagement member hole 5202b at least partially run through each other.

In the embodiment shown in FIG. 7E, a user can place a side edge of a host of a notebook computer used as the electronic device 700 on the support member 5201, and move the engagement member 5202 along the Y-axis direction to engage with the support member 5201, and bumps of the support member hole 5201b and the engagement member hole 5202b are at least partially overlapped on the X-Z plane. Therefore, a distance between the flange 5202a and the support member 5201 can be reduced to an extent that a part of the electronic device 700 can be limited between the flange 5202a and the support member 5201. Then, the user can, for example, pass a hook member 5410 of a lock body 5400 through the support member hole 5201b and the engagement member hole 5202b, and then lock the lock body 5400, that is, the limiting apparatus 805 is in a locked state. In this case, because movement of the engagement member 5202 relative to the support member 5201 is limited by the hook member 5410, and a distance of the flange 5202a relative to the support member 5201 is fixed, to fix the electronic device 700. When the limiting apparatus 805 is in the locked state, a relative position of the lock body 5400 and the limiting apparatus 805 is shown in FIG. 7F.

Although the foregoing descriptions and the accompanying drawings disclose the exemplary embodiments of the present utility model, it should be understood that various addition, many modifications, and substitutions can be used in the exemplary embodiments of the present utility model without departing from the spirit and scope of the principle of the present utility model as defined by the scope of the appended claims. One of ordinary skill in the art of the present utility model should understand that modifications of various forms, structures, arrangements, ratios, materials, elements and components can be made on the present utility model. Therefore, the embodiments disclosed herein should be considered as being configured for describing the present utility model rather than limiting the present utility model. The scope of the present utility model should be defined by the appended claims, covers legal equivalents thereof and is not limited to the foregoing descriptions.

What is claimed is:

1. A limiting apparatus, configured to be used with an electronic device, comprising:
a support member, provided with a support surface, wherein the support surface comprises a convex portion; and
an engagement member, movably engaging with the support member, wherein
when the limiting apparatus is in a locked state, a relative position of the support member and the engagement member is fixed, to limit the electronic device in the limiting apparatus.

2. The limiting apparatus according to claim 1, further comprising:
a housing, an end of the housing being provided with a front end opening, wherein
the support member is fixed outside the front end opening; and
the engagement member is arranged in the housing, rotates relative to the housing, and comprises a front end portion and a rear end portion, wherein the front end portion at least partially protrudes out of the front end opening, and the rear end portion extends along a direction opposite to the front end portion;
a driving apparatus, comprising:
a force application member, comprising a force receiving portion and a force application portion, wherein the force application portion is arranged in the housing, the force receiving portion is connected to the force application portion, and the force application member is rotatable in conjunction relative to the housing; and
a driving member, arranged in the housing, and rotating in conjunction with the force application portion to selectively move on a side of the rear end portion, to enable a distance between the front end portion relative to the support member to change; and
a lock body, arranged on a side of the driving apparatus, wherein when the lock body is locked, the lock body restricts movement of the driving apparatus.

3. The limiting apparatus according to claim 2, wherein the support surface extends along an X-axis, and the X-axis, a Y-axis, and a Z-axis are orthogonal.

4. The limiting apparatus according to claim 3, wherein the engagement member is rotatable relative to the housing along a plane parallel to a Y-Z plane, the force application member is rotatable along a plane parallel to an X-Z plane, and the driving member selectively moves along a Y-axis direction.

5. The limiting apparatus according to claim 3, wherein
the force application portion comprises a limiting portion; and
an end of the driving member engages with the limiting portion in a manner of moving along a Y-axis direction.

6. The limiting apparatus according to claim 5, wherein
the driving apparatus further comprises a displacement limiting member fixed in the housing, the displacement limiting member is internally provided with an accommodation space extending along the Y-axis direction, and a sidewall thread is arranged on a sidewall of the accommodation space; and
the driving member is arranged in the accommodation space, and the driving member is a cylinder whose side surface is arranged with a driving member thread that matches the sidewall thread, wherein
when the force application member rotates, the driving member rotates in conjunction, and the driving member moves along the Y-axis direction through an action between the sidewall thread and the driving member thread.

7. The limiting apparatus according to claim 5, wherein
the housing is internally provided with an accommodation space extending along the Y-axis direction, and a sidewall thread is arranged on a sidewall of the accommodation space; and
the driving member is arranged in the accommodation space, and the driving member is a cylinder whose side surface is arranged with a driving member thread that matches the sidewall thread, wherein
when the force application member rotates, the driving member rotates in conjunction, and the driving member moves along the Y-axis direction through an action between the sidewall thread and the driving member thread.

8. The limiting apparatus according to claim 3, wherein
the lock body comprises the engagement member movable along a Z-axis direction, and when the lock body is locked, an end of the engagement member engages with the force application member, to limit rotation of the force application member.

9. The limiting apparatus according to claim 8, wherein the lock body is a key lock, and the engagement member comprises a convex post.

10. The limiting apparatus according to claim 8, wherein
the lock body is a combination lock, and comprises a shaft movable along a Y-axis direction, wherein the shaft has a shaft end portion; and
the engagement member comprises a bump movable along the Z-axis direction, one side of the bump abuts against the shaft end portion, and when the lock body is locked, another side of the bump engages with the force application member, to limit the rotation of the force application member.

11. The limiting apparatus according to claim 1, further comprising:
a driving apparatus, comprising:
a force application member, wherein the force application member is a cylinder with a partially closed end, and comprises a force receiving portion and a force application portion, wherein the force application portion is a concave portion arranged on an inner side of the partially closed end;
a driving member, wherein an end of the driving member is a polygonal block whose outer contour matches a contour of the force application portion; and
a displacement limiting member, arranged in the force application member, and rotating coaxially with the force application member along a Y-axis direction, wherein a relative position of the displacement limiting member along the Y-axis direction remains unchanged.

12. The limiting apparatus according to claim 1, further comprising:
a housing;
a lock body, arranged in the housing;
a driving apparatus, arranged in the lock body; and
an assembly, separably arranged in the housing and adjacent to the lock body, wherein the support member and the engagement member are assembled in the assembly, to enable the engagement member to rotate relative to the assembly.

13. The limiting apparatus according to claim 1, wherein
one side of the support member is provided with the support surface, and another side of the support member is provided with a support member hole; and
the top of the engagement member is provided with a flange, a side of the engagement member is provided with an engagement member hole, the engagement member is capable of moving transversely relative to the support member and engaging with the support member, and the support member hole and the engagement member hole at least partially run through each other.

14. The limiting apparatus according to claim 1, wherein
one side of the support member is provided with the support surface, and another side is provided with a support member hole; and
the top of the engagement member is provided with a flange, a side of the engagement member is provided with an engagement member hole, the engagement member is capable of moving up and down relative to the support member and engaging with the support member, and the support member hole and the engagement member hole at least partially run through each other.

15. The limiting apparatus according to claim 1, wherein
one side of the support member is provided with the support surface, and another side of the support member is provided with a support member hole; and
the top of the engagement member is provided with a flange, a side of the engagement member is provided with an engagement member hole, the engagement member is capable of moving forward and backward relative to the support member and engaging with the support member, and the support member hole and the engagement member hole at least partially run through each other.
